(19) United States
(12) Patent Application Publication
(10) Pub. No.: US 2010/0138363 A1
(43) Pub. Date: Jun. 3, 2010

(54) SMART GRID PRICE RESPONSE SERVICE FOR DYNAMICALLY BALANCING ENERGY SUPPLY AND DEMAND

(75) Inventors: Troy Batterberry, Kirkland, WA (US); Michaeljon Miller, Bellevue, WA (US); Karen Jaskolka, Redmond, WA (US); Rod Toll, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/483,975

(22) Filed: Jun. 12, 2009

(51) Int. Cl. G06F 1/26; G06Q 10/00; G06Q 50/00; G06F 3/048

(52) U.S. Cl. 705/412; 700/291; 700/297; 700/295; 713/340; 715/810

(57) ABSTRACT

A “Smart Grid Pricer” enables automated balancing of the supply and demand of energy supply and consumption, such as the generation and consumption of electricity between electricity providers and electricity consumers. The Smart Grid Pricer automatically computes and delivers real-time energy pricing information to consumers on behalf of energy retailers (e.g., electricity utilities) to help drive the balance of demand with supply. In various embodiments, real-time pricing is determined by using various probabilistic models to estimate overall consumer demand as a function of factors such as energy price, time of day, region, weather, etc. to compute a price that will result in an energy demand that is closely balanced to the available supply. On the consumer side, various components of the Smart Grid Pricer automatically respond to such pricing information to optimize energy consumption in accordance with a variety of automated and/or user defined rules and preferences.

### BACKGROUND

1. Technical Field

A “Smart Grid Pricer” provides a highly scalable price response intermediary service for balancing energy supply and demand between energy providers and energy consumers in real time, with respect to the generation, transmission, distribution, and consumption of energy sources such as electricity, heating oil, natural gas, etc.

2. Related Art

Major disruptions are taking place in the energy industry. Environmental concerns and a desire for energy independence are driving regulatory requirements and government spending for renewable energy sources that fundamentally impact generation, transmission, distribution, and demand-side management. Solar, wind, and tidal energy are promising sources of renewable energy. Such energy sources will likely play an increasing role in growing supply capacity. Unfortunately, however, these types of energy sources cannot always be dispatched based on demand. Instead, generation can only occur when the sun is shining, the wind is blowing, or the tides are flowing appropriately. Consequently, renewable energy production varies considerably as a function of time that does not necessarily correspond with energy demand.

As a result, renewable energy sources can be far less dependable than conventional energy sources for consistently satisfying demand over a large population base. Moreover, as storage of excess electrically is not currently economically viable, “renewable” electricity must generally be used as it is generated. The result is that renewable distributed generation, with its highly variable capacity based on factors such as the sun, wind, tidal flows, etc., generally requires more demand elasticity to drive consumption when electricity is cheap and available, and drive conservation when it is not.

Further, a significant portion, approximately 15-25%, of utility provider costs to acquire electricity is attributable to handling peak usage loads. More specifically, temporary spikes in the consumption of electricity, often occurring on particularly hot or cold days, and often only a few hours in duration, result in significantly higher electricity acquisition costs for the utility and ultimately the electricity consumer. In addition, the mechanisms used to generate incremental electricity to satisfy temporary spikes are often less environmentally friendly (e.g., existing coal power plants brought online to meet temporarily increased demand).

One conventional technique for partially addressing such issues is generally referred to as automated Demand Response (DR), or simply “Auto DR.” With Auto DR, the electrical utility or broker sends out an activation signal to participating homes or businesses (i.e., participating consumers). The participating consumers automatically respond to the signal by reducing or stopping electricity usage across heaters, air conditioners, and other non-critical appliances and/or devices. In general, an Auto DR program motivates the energy usage behavior of the consumer through incentives on the consumer's monthly bill. These incentives typically reward the consumer for participating through the hot months of the summer. In exchange for this incentive, consumers agree to have their air conditioner thermostat subjected to temporary automated set-backs, and to having various other power consuming devices temporarily cycled off when a peaking event occurs.

The problem of peak energy demand times is also seen in the cost incurred by utilities to acquire electricity for subsequent delivery and sale to the consumer. In particular, the cost of procuring or generating energy for delivery to the consumer typically varies depending on the time of the day and the day of the week, with more expensive generating plants typically only being brought online in times of higher energy demand. For example, per kilowatt-hour costs are generally much higher during peak hours and during weekdays. This is due to a variety of factors, including the use of more expensive “peaker” generational equipment to meet peak load capacity. With the use of “smart meters,” utilities are shifting from flat-rate kilowatt-hour pricing to predetermined and pre-published “time of day pricing” (TDP) to help incent peak load reduction and to pass on the actual costs to the end users that consume the energy.

In general, TDP requires smart metering technology to measure usage at different time intervals. TDP has already been rolled out in some regions where smart meters have been installed and regulatory approval has been granted. This TDP-based pricing information is made available to the consumer so they can direct their energy usage as appropriate for their specific needs. Similar systems use pricing tables that are graduated depending upon usage. For example, the first 200 kWh of usage can be at one level, while the next 201-500 kWh of usage can be at relative higher levels.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A “Smart Grid Pricer,” as described herein, provides various embodiments of a highly scalable price response intermediary service for balancing energy supply and demand between energy providers and energy consumers in real time using an automated market-based approach. In general, the Smart Grid Pricer automatically computes and delivers real-time pricing information for electricity, or other energy sources, to consumers on behalf of electricity retailers to help drive the balance of demand with supply. As with typical market-driven consumption patterns, it is expected that consumption (i.e., energy use) will decrease as the energy price is increased. Conversely, as the price is decreased, it is expected that energy consumption will increase. The Smart Grid Pricer uses these concepts to help in balancing generation, transmission, distribution, and consumption of various energy sources with respect to potentially millions of consumers in any particular local energy market.

Note that for purposes of explanation the following discussion will generally refer to the generation and consumption of electrical energy. However, it should be understood that the Smart Grid Pricer is fully capable of balancing supply and demand of other energy sources, such as, for example, natural gas, heating oil, etc. It should also be noted that while consumers are generally discussed in terms of homes, the term “consumer” is also intended to refer to any entity or business that consumes energy.

More specifically, the Smart Grid Pricer enables an automated balance of the supply and demand of electricity between electricity providers and electricity consumers. The Smart Grid Pricer automatically computes and delivers real-time pricing information for electricity to consumers on behalf of electricity retailers to help drive the balance of demand with supply. On the consumer side of the Smart Grid Pricer, various components of the Smart Grid Pricer automatically respond to such pricing information to optimize energy consumption in accordance with a variety of automated and/or user defined rules and preferences.

A simple example of some of these concepts is an automated control for a particular consumer that will automatically turn down (or turn off) an air conditioner when the price of electricity reported to the consumer by the Smart Grid Pricer exceeds some pre-determined threshold. Other rules or preferences that may be used in cooperation with this example include current temperature preferences, time of day, local weather forecasts or conditions, etc. Another simple example is an electric clothes dryer that automatically starts or stops either as a function of real-time electricity costs or as a function of forecast electricity costs for some point in the future.

In view of the above-cited examples, it is important to understand that while automated consumer-based controls are enabled by the use of the real-time pricing provided by the Smart Grid Pricer, consumers, or particular consumer devices, are not required to modify energy consumption as a function of energy pricing. For example, energy price may not be a significant factor in energy usage in particular cases such as, for example, a freezer full of food (or other perishables) that must be kept below some predetermined temperature. Further, it is also important to understand that various embodiments of the Smart Grid Pricer include fallback or failsafe controls such that if there is a partial or complete system failure of the Smart Grid Pricer, automated devices under the control of the Smart Grid Pricer simply default to a manual control state. This default behavior ensures that the individual user or consumer can always interact with devices as if they were not coupled to or controlled in any way by any element of the Smart Grid Pricer.

Several general components are used to enable the various balancing capabilities of the Smart Grid Pricer. First, the Smart Grid Pricer includes an automated energy pricing service for real-time pricing of the energy being consumed. Real-time pricing is intended, at least in part, to drive overall consumption, as noted above. In various embodiments, various probabilistic or statistical models are used to evaluate consumer behavior over time (typically on an anonymized basis) in order to provide an accurate forecast of energy demand as a function of factors such as energy price, local weather conditions, time of day, time of year, region, etc. This demand forecast is then balanced with actual or expected energy production to arrive at a price that is expected (in view of the modeled price-based consumer energy usage behavior) to ensure that demand does not outpace supply (which can result in potential brownouts, blackouts, or power grid failures).

In combination with the real-time pricing service, the Smart Grid Pricer includes a pricing delivery mechanism that reports the current price in real-time or near real-time to consumers (or to automated control devices, such as light dimmers, thermostats for HVAC units, etc.). In addition, since energy pricing potentially fluctuates in real-time, the Smart Grid Pricer uses consumer-based energy meters, typically referred to as “smart meters” that measure and either record or report the energy use of individual consumers as a specific function of time so that the consumer can be charged in accordance with the real-time pricing of the consumed energy.

In view of the above summary, it is clear that the Smart Grid Pricer described herein provides various techniques for enabling a highly scalable price response intermediary service for balancing energy supply and demand between energy providers and energy consumers in real time. Such balancing includes the generation, transmission, distribution, and consumption of energy sources such as electricity, heating oil, natural gas, etc. In addition to the just described benefits, other advantages of the Smart Grid Pricer will become apparent from the detailed description that follows hereinafter when taken in conjunction with the accompanying drawing figures.

### DESCRIPTION OF THE DRAWINGS

The specific features, aspects, and advantages of the claimed subject matter will become better understood with regard to the following description, appended claims, and accompanying drawings where:

FIG. 1 illustrates a general flow diagram for using a “Smart Grid Pricer” as an intermediary between energy providers and energy consumers to balance supply and demand of energy as a function of real-time energy pricing, as described herein.

FIG. 2 provides an exemplary architectural flow diagram that illustrates program modules for implementing various embodiments of the Smart Grid Pricer, as described herein.

FIG. 3 is a general system diagram depicting a simplified general-purpose computing device having simplified computing and I/O capabilities for use in implementing various embodiments of the Smart Grid Pricer, as described herein.

### DETAILED DESCRIPTION OF THE EMBODIMENTS

In the following description of the embodiments of the claimed subject matter, reference is made to the accompanying drawings, which form a part hereof, and in which is shown by way of illustration specific embodiments in which the claimed subject matter may be practiced. It should be understood that other embodiments may be utilized and structural changes may be made without departing from the scope of the presently claimed subject matter.

1.0 Introduction:

In general, a “Smart Grid Pricer,” as described herein, provides various techniques for enabling a highly scalable price response intermediary service for balancing energy supply and demand between energy providers and energy consumers in real time. Such balancing includes the generation, transmission, distribution, and consumption of various energy sources.

It should be noted that for purposes of explanation, the following discussion will generally refer to the generation and consumption of electrical energy. However, it should be understood that the Smart Grid Pricer is fully capable of balancing supply and demand of other energy sources, such as, for example, natural gas, heating oil, etc. Further, in various embodiments, the Smart Grid Pricer can also use similar techniques to price water delivery and consumption in real-time. Such embodiments can be used, for example, to encourage irrigation in the evening rather than during the day during hot summers. It should also be noted that while consumers are generally discussed in terms of users in individual homes, the term “consumer” is also intended to refer to any entity or business that consumes energy.

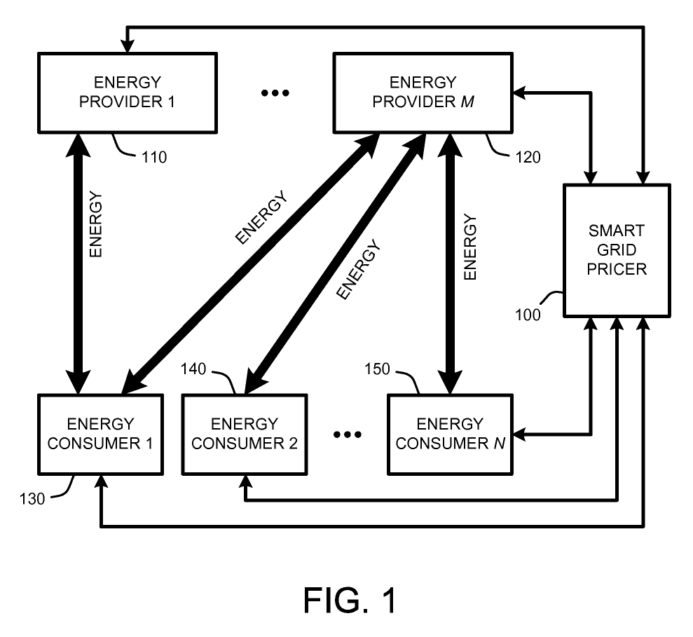

More specifically, as illustrated by FIG. 1, the Smart Grid Pricer 100 enables automated balancing of the supply and demand of energy supply and consumption between energy providers (110, 120) and electricity consumers (130, 140, 150). This balance is achieved through an automated market-based approach wherein the Smart Grid Pricer 100 determines, sets, and reports energy prices to the energy consumers (130, 140, 150) in real-time on behalf of the energy providers (110, 120) to drive energy demand and consumption relative to the available energy supply. In various embodiments, real-time pricing is determined by using various probabilistic models to estimate overall consumer demand as a function of factors such as energy price, time of day, region, weather, etc., to compute a price that will result in an energy demand that is closely balanced to the available supply. On the consumer side, various components of the Smart Grid Pricer automatically respond to such pricing information to optimize energy consumption in accordance with a variety of automated and/or user defined rules and preferences.

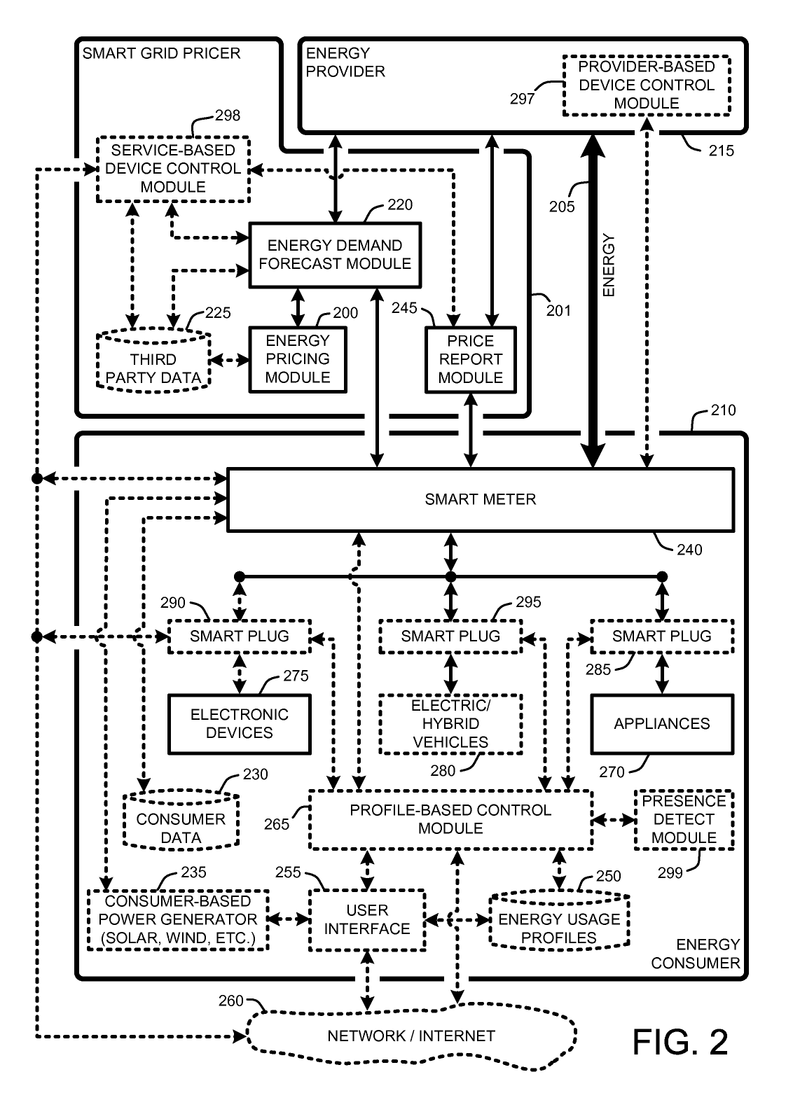

In addition, as discussed below with respect to FIG. 2, in various embodiments, the Smart Grid Pricer also provides for various remote control and interaction features with one or more electronic devices, appliances, electric vehicles, etc.

1.1 System Overview:

As noted above, the “Smart Grid Pricer,” provides various techniques for balancing the supply and demand of energy supply and consumption between energy providers and energy consumers. This balancing is enabled by determining and reporting real-time energy pricing information to consumers on behalf of energy retailers (i.e., “energy providers”) to help drive the balance of demand with supply. The processes summarized above are illustrated by the general system diagram of FIG. 2. In particular, the system diagram of FIG. 2 illustrates the interrelationships between program modules for implementing various embodiments of the Smart Grid Pricer, as described herein. Furthermore, while the system diagram of FIG. 2 illustrates a high-level view of various embodiments of the Smart Grid Pricer, FIG. 2 is not intended to provide an exhaustive or complete illustration of every possible embodiment of the Smart Grid Pricer as described throughout this document.

In addition, it should be noted that any boxes and interconnections between boxes that may be represented by broken or dashed lines in FIG. 2 represent alternate embodiments of the Smart Grid Pricer described herein, and that any or all of these alternate embodiments, as described below, may be used in combination with other alternate embodiments that are described throughout this document.

In general, as illustrated by FIG. 2, the processes enabled by the Smart Grid Pricer 201 begin operation by using an automated energy pricing module 200 to determine real-time pricing for energy 205 that is distributed to an energy consumer 210 by an energy provider 215. Note that for purposes of explanation, FIG. 2 illustrates a single energy consumer 210 and a single energy provider 215. However, in actual use, it is expected that potentially many millions of energy consumers will be variously connected to one or more energy providers while the energy pricing module 200 (or multiple instances of the energy pricing module, depending on factors such as number of consumers, geographic considerations, which energy consumers are connected to which energy providers, etc.) determines real-time pricing for all such energy consumers.

As described herein, the price determined by the energy pricing module 200 is set at a level that is expected to balance the available energy supply with the current demand. It is also important to understand that the forecasted energy demand is limited by the available energy supply, as reported to the energy demand forecast module 220 by the energy provider 215. The real-time pricing determined by the energy pricing module 200 is based on energy usage forecasts provided by an energy demand forecast module 220. In general, as discussed in further detail in Section 2.2, the energy demand forecast module 220 uses a probabilistic or statistical model to evaluate the behavior of one or more groups of energy consumers 210 over time in order to provide an accurate forecast of energy demand as a function of energy price relative to the available energy supply.

In various embodiments, third party data 225, such as current or forecast weather, appliance or device energy consumption data, consumer energy usage metrics, etc., is also provided to the energy demand forecast module 220 for use in determining real-time energy pricing in cooperation with the energy pricing module 200.

Further, in various embodiments, the energy demand forecast is also based on specific consumer data 230, such as building characteristics, energy consumption devices, local weather conditions, occupancy information, etc. In related embodiments, the energy demand forecast module 220 also considers the input of consumer-based power generation 235, such as solar or wind generated power, for example, that is used to either offset the energy consumption of that energy consumer 210, or is received into the energy grid as excess consumer generated power for use by other consumers.

In general, it is expected that information such as consumer data 230 and data regarding consumer generated power inputs into the grid will be reported to the energy forecast module 220 via a “smart meter” 240 (see Section 2.4 for a discussion of smart meters). However, other wired or wireless communications channels, such as, for example, the Internet or other network 260, can also be used to report such information from the energy consumer 210 to the energy demand forecast module 220. Note that such information can also be used to track energy consumer 210 power inputs to the overall grid for use in billing purposes.

In combination with the real-time pricing computed by the energy pricing module 200, the Smart Grid Pricer 201 includes a price report module 245 that provides a pricing delivery mechanism that reports the current energy price to both energy consumers 210 and energy providers 215. However, in various embodiments, the price report module 245 staggers reporting of pricing changes to groups of consumers over some period to help reduce spikes in energy demand. In other words, instead of telling a complete group of consumers at once that the price of energy has dropped (or increased), the group is informed in subgroups of some desired size via a staggered series of pricing updates. Such embodiments help to avoid the case where large numbers of automated appliances or devices begin drawing power simultaneously (or are turned off simultaneously), which could result in either a power spike (or surplus capacity) that could damage the power distribution system.

Once the energy consumer 210 receives the real-time pricing information from the price report module 245, the energy consumer reacts to that pricing information by increasing energy consumption, decreasing energy consumption, or maintaining current energy consumption. Specifically how each individual energy consumer 210 reacts to pricing updates will depend on a number of factors, such as, for example, what the consumer is willing to pay for electricity, either in general, or an a per device or per appliance basis. As discussed in Sections 2.5 through 2.7, in various embodiments, the energy consumer 210 selects, edits, or defines one or more energy usage profiles 250 via a user interface 255 that is available for either local access, or secure remote access via the Internet or other network 260. See Section 2.6 for a further discussion of energy usage profiles.

When using energy usage profiles 250, the energy consumer 210 responds to real-time or future forecast pricing by using a profile-based control module 265 to control attached electronics, such as, for example, appliances 270, electronic devices, hybrid-electric vehicles (HEV) 280, etc. Control of such electronics is provided either directly, in the case of “smart” electronics that include network-based control capabilities, or via “smart plugs” (285, 290, 295) between the electrical outlet and the device being controlled. It should also be noted that in various embodiments, the smart plugs (285, 290, 295) can act in direct response to pricing signals received via the smart meter 240, via the Internet or other network 260, or via the user interface 255, to turn particular devices on or off, or to adjust the energy expenditures of such devices. See Section 2.5 for a detailed discussion of “smart plugs.”

In addition to device control via the profile-based control module 265, in various embodiments, one or more of the electronics operating within the energy consumer 210 are remotely controlled via a provider-based device control module 297 residing in or under the control of the energy provider 215. Such embodiments are similar to conventional automated Demand Response systems that allow an electricity provider to turn off air-conditioning units or other non-essential electronics devices from a remote location in order to balance power distribution loads. However, unlike conventional automated Demand Response systems, the provider-based device control module 297 operates in response to the real-time pricing and/or the forecasted energy demand reported by price report module 245 and the energy demand forecast module 220, respectively.

Similar embodiments allow remote instances of the Smart Grid Pricer 201 to remotely control one or more of the electronics operating within the energy consumer 210 via a service-based device control module 298 residing in or under the control of the Smart Grid Pricer 201. As with the provider-based device control module 297, the service-based device control module 298 also operates in response to the real-time pricing and/or the forecasted energy demand reported by price report module 245 and the energy demand forecast module 220, respectively. In various embodiments, the service-based device control module 298 has the capability (using conventional secure communications protocols) to control the on-off states or various power settings of one or more devices either by direct access to one or more of the smart plugs (285, 290, 295), through the smart meter 240 in a manner similar to the provider-based device control module 297, via the user interface 255 (using the Internet or other network 260), or via direct access to the profile-based control module 265 (again using the Internet or other network 260). Note that as discussed in further detail below various embodiments of the Smart Grid Pricer 201 include fallback or failsafe controls such that if there is a partial or complete system failure affecting the dervice0based control module 298 (or other elements of the Smart Grid Pricer), automated devices under the control of the Smart Grid Pricer simply default to a manual or local control state.

Finally, in various embodiments, a presence detect module 299 uses conventional techniques, such as, for example optical, microwave, or infrared (IR) based sensors to determine whether any people are present within the premise of a particular energy consumer 210. In other words, the presence detect module 299 determines whether anyone is home at some particular point in time. The presence detect module 299 then reports the occupancy status of the premise to the profile-based control module 265 which in turn automatically selects an appropriate energy usage profile 250 depending upon whether any people are present or not. See Section 2.6 for an additional discussion of occupancy detection and energy usage profiles.

2.0 Operational Details of the Smart Grid Pricer:

The above-described program modules are employed for implementing various embodiments of the Smart Grid Pricer. As summarized above, the Smart Grid Pricer provides various techniques for balancing the supply and demand of energy supply and consumption between energy providers and energy consumers. The following sections provide a detailed discussion of the operation of various embodiments of the Smart Grid Pricer, and of exemplary methods for implementing the program modules described in Section 1 with respect to FIG. 2. In particular, the following sections examples and operational details of various embodiments of the Smart Grid Pricer, including: an operational overview of the Smart Grid Pricer; energy pricing models; reporting real-time energy pricing to consumers; conventional “smart meters”; real-time energy usage monitoring and logging via “smart plugs; occupancy detection and energy use profiles; and user specified cost and energy usage caps.

2.1 Operational Overview:

As noted above, the Smart Grid Pricer-based processes described herein provide various techniques for balancing the supply and demand of energy supply and consumption between energy providers and energy consumers using an automated market-based approach. This automated balancing is generally accomplished by determining and reporting real-time energy pricing information to consumers on behalf of energy retailers to help drive the balance of demand with supply. In particular, the Smart Grid Pricer considers the forecast reaction of electricity consumers to help the electricity supplier set the proper price(s) of the electricity. If the price is set too high, too much demand will be shed and the supplier will be left with a real-time surplus of electricity. If the price is set too low, demand will increase, and an undersupply condition could cause the grid to experience a brownout or other failure condition.

In other words, as the energy price is increased, as with typical market-driven consumption patterns, it is expected that consumption (i.e., energy use) will decrease. Conversely, as the price is decreased, it is expected that energy consumption will increase. As such, the Smart Grid Pricer balances generation, transmission, distribution, and consumption of various energy sources by providing real-time energy pricing to consumers at levels that will either drive energy demand up or down in order to balance demand relative to supply.

Further, on the consumer side of the Smart Grid Pricer, various components of the Smart Grid Pricer automatically respond to the real-time pricing information to optimize energy consumption in accordance with a variety of automated and/or user defined rules and preferences. In related embodiments, this pricing information is also provided directly to the consumer (via automated messaging techniques, email, display devices, etc.) to allow the consumer to manually adjust various energy consumption behaviors, if desired. Consequently, the Smart Grid Pricer also enables the consumer to determine the most appropriate times to consume electricity for tasks that are capable of being shifted in time (e.g., doing laundry or running large machinery when electricity is cheaper).

More specifically, electricity retailers ultimately need to set and communicate the energy pricing information to electricity consumers, while consumers react to that pricing information in their use of energy. The Smart Grid Pricer facilitates these roles of the producer and consumer by acting as an intermediary to both determine and report energy pricing information in real-time.

As noted above, the Smart Grid Pricer calculates optimal real-time energy prices. Factors that are considered by the Smart Grid Pricer in determining energy pricing include, but are not limited to: forecast aggregate load and supply; information retrieved from or reported by consumers as to how they will respond to pricing; current energy usage; historical energy usage; current and forecast weather; time of day; delivery costs of electricity (e.g., attenuation or loss of electricity during transmission to consumer); carbon and other pollutant emissions costs for relevant supplies; etc. Further, once the optimal energy pricing has been determined, in various embodiments, the Smart Grid Pricer staggers reporting of pricing signals to individual consumers to avoid rapid changes in demand across the supply grid.

Note that in various embodiments, the computed energy price varies continuously over time, or is fixed for some period (e.g., seconds, minutes, or hours), depending upon current demand conditions. Consequently, in such embodiments, expiration times associated with real-time prices are reported to the consumer along with the current price. In related embodiments, future energy pricing is computed and reported to consumers by forecasting energy demand at future times based on the same or similar criteria as used for computation of real-time energy pricing. In such cases, the future prices are reported to consumers along with the start and end times of those prices. Note that such pricing may be provided to the consumer as best guess type estimates rather than fixed prices, if desired, since unknown future events (e.g., storms, power generation failures, etc.) may change the energy demand picture.

In various embodiments, energy pricing is further customized based on various factors, or for particular consumers or groups of consumers. For example, customized energy pricing can be delivered to individual consumers such as low-income families that may be offered a reduced or subsidized energy rate. Energy pricing can also differ for consumers served by particular energy transmission and distribution links.

In addition, since it is intended that the consumer will rely on the pricing information that is reported by the Smart Grid Pricer, it is important that the pricing information is trustworthy. Consequently, in various embodiments, pricing information is delivered or reported to individual consumers using conventional tamper-resistant messaging techniques such as, for example, the use of encrypted messages or other conventional key-based messaging techniques. Similarly, in related embodiments, individual consumers, or local consumer based elements of the Smart Grid Pricer, can report back to the remote pricing service of the Smart Grid Pricer to indicate secure receipt and validation of particular energy pricing reports. Note that secure messaging techniques for ensuring data security are well known to those skilled in the art, and will not be described in detail herein.

On the consumer side of the Smart Grid Pricer system, electricity consumers make use of the Smart Grid Pricer in combination with appropriate connected energy consuming devices to automatically react to the pricing signals. In particular, in various embodiments, the consumer side of the Smart Grid Pricer includes an internet or network-based application service for consumers to define and remotely update their energy consumption preferences. Such preferences include, for example, automatically managing consumer energy usage (e.g., discretionary appliances, tolerable temperatures for heating, cooling, water heaters, etc), setting thresholds for pricing for individual appliances (e.g., allow the A/C to run when pricing drops below the threshold), electronic car consumption patterns (e.g., charge car batteries or use electricity to generate hydrogen for the car from a natural gas source or electrolysis of water), energy consumption based on the consumer's budget, etc. In other words, Smart Grid Pricer provides the energy consumer (e.g., individual homeowners, businesses, etc.) with the capability to granularly define the behavior of electronic devices, appliances, etc.

Further, in controlling various devices and appliances on the consumer side, various embodiments of the Smart Grid Pricer include a “rules engine” that evaluates various inputs to automatically control appliances and other energy consuming devices. These inputs include, but are not limited to: consumer preferences; current and forecast weather; current time; historical and current energy usage; current and forecast pricing of electricity and other energy sources, such as natural gas or heating oil; tiered pricing implications (e.g., price differences for predefined amounts or blocks of energy used per month); thermal characteristics of the home or business; historical usage patterns; current and forecast occupant presence and schedules; characteristics of Heating Ventilation and Air Conditioning (HVAC) equipment; allocated budget, etc.

It should also be noted that in various embodiments, rather than reporting pricing information to individual consumers via push-type communications (i.e., pricing automatically sent to the consumer), the consumer side of the Smart Grid Pricer contacts the local energy provider and requests or pulls that pricing information as needed. In various embodiments, the energy pricing information is digitally signed or otherwise encrypted by the electricity retailer to prevent unauthorized tampering.

2.2 Consumer Demand Models for Real-Time Energy Pricing:

As noted above, the real-time energy pricing provided to consumers creates a demand elasticity that drives energy demand when electricity is cheap and available, and curtails energy demand when it is not. In other words, the Smart Grid Pricer synchronizes energy producers and consumers across a variety of electricity ecosystem participants by dynamically determining the appropriate prices of electricity in real time for individual consumers in order to alter consumption on a scale large enough to align consumption with the available energy supply.

In order to compute appropriate real-time pricing to achieve this balance, the Smart Grid Pricer evaluates information received from a variety of extensible sources and extensible expert systems in order to calculate the appropriate price signals. The real-time pricing information is then transmitted to the affected parties. In essence, Smart Grid Pricer provides a massive extensible distributed control system driven by a variety of supply side and demand side inputs to an expert system, such as a probabilistic or statistical model, that is used to calculate and deliver both dynamic pricing information and other related control signals in real-time or near real-time. Note also, that in various embodiments, electricity producers can specify upper or lower limits on the real-time pricing computed by the Smart Grid Pricer.

Examples of supply side inputs include: generation capacity (current and forecast) and energy cost, dependent transmission load, capacity, efficiency, and cost information (current and forecast), and dependent distribution load, capacity, efficiency, and cost information (current and forecast). On the demand side, examples of inputs include: per premise (i.e., individual consumer location) demand estimates, occupant and/or facilities manager preferences (e.g., thresholds for comfort, pricing, etc.) that are anonymized for privacy purposes, consuming device characteristics, state, and forecast usage, sourcing devices characteristics, state, and forecast usage, building thermodynamic characteristics, heating and cooling system characteristics, weather (current and forecast), occupancy presence (current and forecast), meter usage information, and historical usage information.

As noted above, the real-time energy pricing is based on various factors such as actual or anticipated supply and energy usage forecasts that are evaluated by probabilistic or statistical models in order to provide an accurate forecast of energy demand as a function of energy price. Note that such demand forecasting can be performed at any granularity desired, such as, for example, at the level of the individual consumer (or groups of consumers), at the level of one or more neighborhoods or regions, or on a citywide, countywide, statewide, countrywide, or even global level.

This demand forecast is then balanced with expected energy production to arrive at a price that is expected to ensure that energy consumption does not outpace supply (which can result in potential brownouts, blackouts, or power grid failures). In related embodiments, monitoring or reporting of real-time changes in energy production is reflected in the expected energy production used to compute the real-time pricing for balancing the supply and demand of the available energy. Such real-time changes to energy production may be based on any of a number of factors, including, for example, energy plants coming online or going offline (either scheduled or unscheduled), changes in total power output resulting from changing conditions (e.g., heavy clouds over a solar power plant), etc. In addition, given the demand forecast, the Smart Grid Pricer can then also reserve energy transmission and distribution assets, as well as dispatch any available incremental generation as appropriate. For example, the Smart Grid Pricer can use energy consumption modeling to recommend when to bring power plants or generators online or take the power plants or generators offline.

2.3 Reporting Real-Time Energy Pricing to Consumers:

In general, by forecasting an appropriate energy price based both on predicted future supplies and the resulting forecast demands, prices can be set at optimal levels, as discussed in Section 2.2. The Smart Grid Pricer securely delivers this customized pricing information to the consumer's premise (e.g., the “smart meter” or Smart Grid Pricer elements at the consumer's home). The consumer side of the Smart Grid Pricer then automatically reacts to the real-time pricing information to drive demand, as discussed herein.

More specifically, energy providers have the ability to communicate customized pricing information in real-time to consumers via the Smart Grid Pricer. The Smart Grid Pricer also ensures that energy producers have the ability to forecast the response of consumers at a given price. Consumers have the ability to receive dynamic pricing information and define preferences for how they want their electricity consuming devices to respond to such pricing changes. Further, given these forecasting capabilities, the Smart Grid Pricer is also capable of informing consumers of impending peak energy loading events or pricing changes expected at some point in the future.

For example, by informing the consumer in advance of expected energy pricing increases or decreases, the consumer can choose to perform energy intensive tasks at a time when energy is less expensive. A simple example of this concept is given by a pricing forecast for several days in the future that indicates an expected spike in energy usage based on a weather report that forecasts an intense summer heat wave. In this case, the consumer is informed that electricity costs are likely to be more expensive (using forecast energy prices that may differ from the actual real-time pricing) when the heat wave arrives. The consumer can then choose to perform energy intensive tasks (such as running an electric clothes dryer, for example) before the expected spike in energy prices.

In related embodiments, the pricing reported to consumers is also guaranteed for some period of time (e.g., 30 minutes, for example) so that consumers can begin or complete particular tasks or operations with an expectation that pricing will suddenly rise to a point that forces them to terminate some task prematurely.

2.4 Smart Meters:

As noted above, the Smart Grid Pricer, as described herein, makes use of “smart meters” to enable real-time consumer reaction to the real-time energy pricing reported to consumers. In addition, the use of such smart meters allows consumers to be correctly billed for using energy at the reported energy prices at the time that those prices were valid.

As is known to those skilled in the art, a “smart meter” is a meter such as an electrical meter, natural gas meter, water meter, etc., that captures consumer usage data as a function of time. For example, while conventional electrical meters generally measure total consumption over some period between measurements, a “smart” electrical meter provides various techniques for measuring specifically when the energy was consumed. This information is then generally periodically transmitted to the utility provider or other third party via a wired or wireless network connection for use in monitoring and billing purposes.

It should also be noted that such smart sensors generally include features such as real-time or near real-time usage sensors, power outage notification, power quality monitoring, etc. In general, such “smart meters” are known to those skilled in the art, and will not be described in detail herein.

In addition, since energy usage information using smart meters is collected as a function of time for each consumer, this information is used in various embodiments of the Smart Grid Pricer to update or refine the probabilistic or statistical pricing models used for determining real-time energy pricing. See Section 2.2 for a discussion of energy pricing models.

2.5 “Smart Plugs” for Monitoring and Controlling Energy Usage:

In addition to smart meters, in various embodiments, the Smart Grid Pricer makes use of “smart plugs.” In general, a smart plug is a communicating plug that sits in-line between the wall outlet and an appliance or device. In various embodiments, smart plugs perform one or both of two basic functions. First, in various embodiments, the smart plug exposes remote on/off switch state control to the Smart Grid Pricer or provides Internet or network access to allow secure user or third party control, if desired). Second, in various embodiments, smart plugs optionally measure wattage and report consumption back to the Smart Grid Pricer for later analysis. Exposing the remote on/off switch state control to the Smart Grid Pricer allows the smart plug to provide scheduling as to when it will turn on or off (thereby turning on or off any attached appliance or electrical device).

Note that “smart plug” type technology may also be directly integrated into various devices rather than being connected inline between the device and the power source. In general, the optional “smart plug” component of the Smart Grid Pricer is a low energy device that does not significantly increase energy usage. Further, in various embodiments, these smart plugs include a manual override option to temporarily or permanently bypass either or both centralized control by the Smart Grid Pricer or reporting to the Smart Grid Pricer.

In embodiments where wattage is measured and reported back to the Smart Grid Pricer, local energy consumption (on a per-device basis) is reported by each smart plug to a local consumer component of the Smart Grid Pricer that evaluates and summarizes energy use for the individual consumer. Such information can be presented to the consumer in a number of formats, such as energy use as a function of time, energy use per device, total energy use for a specified period, energy use compared to other households, etc. However, in various embodiments, this information is also reported back to the remote pricing service component of the Smart Grid Pricer for use in updating the consumer demand models. Note that in the case that specific usage information is reported back to the remote pricing service, this information is anonymized to protect the privacy of individual consumers.

Examples of representative consumer devices and appliances that can be measured and controlled through a smart plug include, but are not limited to, refrigeration devices, clothes dryers, clothes washers, electronic gear such as computers, stereos, etc. For example, modern refrigerator/freezers consume considerable amounts of energy. In order to shift peak loads, they can typically be powered off for short periods of time without incurring any damage to the food stored inside. Therefore, so long as the internal temperature remains at or below a predetermined safe temperature, smart plugs can be used to automatically turn off the refrigerator or freezer at times when electricity costs are high.

Space heaters, pool pumps, clothes washers and dryers, etc., represent a simpler case for automated control since their on/off state is generally not considered critical, as in the case of food temperature in a refrigerator or freezer. For example, clothes washers or dryers can be automatically powered on or off (or their operation time-shifted), depending upon the real-time energy pricing provided by the Smart Grid Pricer. However, as with all such devices, the user is free to manually control the appliance regardless of the real-time pricing. Further, by connecting other non-essential consumer electronics gear such as computers, stereos, and other consumer electronic gear to smart plugs, such devices can be automatically powered down in order to save energy, especially in the case that no one is home or currently using a particular device. See Section 2.6 for a discussion on occupancy detection for use in controlling the on/off state or other parameters of particular devices.

Further, in view of the above-cited examples, it is important to understand that while automated consumer-based controls are enabled by the use of the real-time pricing provided by the Smart Grid Pricer, consumers, or particular consumer devices, are not required to modify energy consumption as a function of energy pricing. For example, energy price may not be a significant factor in energy usage in particular cases such as, for example, a freezer full of food (or other perishables) that must be kept below some predetermined temperature. Further, it is also important to understand that various embodiments of the Smart Grid Pricer include fallback or failsafe controls such that if there is a partial or complete system failure on the consumer side, automated devices under the control of the Smart Grid Pricer simply default to a manual control state. This default behavior ensures that the individual user can always interact with devices as if they were not coupled to or controlled by any element of the Smart Grid Pricer.

2.6 Occupancy Detection and Energy Usage Profiles:

In general, device sensors and controllers within the home or consumer network are capable of providing occupancy information to the Smart Grid Pricer to help optimize automatic control of items such as thermostats, lighting, etc. For example, in various embodiments of the Smart Grid Pricer, the detection of occupants in the home is factored into controlling or setting devices such as thermostats, and for enabling other scenarios such as profile control. For instance, if no one is detected in the home (using conventional techniques such as IR or microwave-based motion detection devices, cameras, microphones, etc.), the thermostat can be automatically adjusted to a more economical level by the Smart Grid Pricer while powering down one or more non-essential lights or other devices. Then, once someone is detected in the home or premise, the thermostat and/or lights and other devices can revert to an energy usage “profile” suited for an occupied home.

In an ideal energy usage scenario, daily operational tasks required of the homeowner to optimize energy usage are strictly minimized and preferably eliminated. Consequently, in various embodiments, the Smart Grid Pricer provides a set of one or more standard energy “profiles” from which the user can select and customize, if desired. In general, these energy profiles allow the Smart Grid Pricer to intelligently trigger on/off states or settings of various devices (via the aforementioned “smart plugs”) based either on pre-set schedules or through events such as a determination that everyone has left the house. These profiles typically control a multitude of appliances, devices, and lighting. As with individual smart plugs, simple manual override of such profiles is enabled in various embodiments for situations where schedules or individual user needs deviate from the routine defined by a particular profile.

As noted above, one or more energy usage profiles can be selected or customized by the user. In general, selection and customization of such profiles is provided using various communications interfaces. For example, in various embodiments, selection, programming and/or customization of such energy usage profiles are accomplished using a typical PC-type computer or the like. In general, the consumer is provided with a simple user interface that allows the consumer to select, specify, or edit default settings for some or all devices coupled to the Smart Grid Pricer via the aforementioned smart plugs. Similar interfaces are provided using other communications interfaces such network, Internet, or cell phone based interfaces that allow the energy consumer select, specify, or edit any desired settings for one or more usage profiles. In either case, it should be understood that selection or modification of such profiles can be accomplished either locally or remotely. In the remote access case, the Smart Grid Pricer provides a conventional secure interface (e.g., password protected, smart card, biometric protections, etc.) that allows the user to log into and view, select or modify his energy usage profiles from a remote location.

As noted above, various energy usage profiles are predefined for selection and/or customization by the energy consumer or user. Following is list of a few basic profiles that are predefined for use with the Smart Grid Pricer. Note that the following list of profiles is provided only for purposes of explanation and example, and is not intended to be a complete listing of possible or available energy usage profiles.
1. “At Home Comfort Profile”: One example of a pre-defined energy usage profiles from which the user/consumer can select includes an “at home comfort profile” that maximizes user comfort and convenience in the home at the potential cost of increased energy consumption.
2. “At Home Economy Profile”: Another example of a pre-defined energy usage profile includes an “at home economy profile” that reduces energy consumption while still striking a balance with homeowner comfort (e.g., reduce HVAC energy expenditures and dim the lights).
3. “Night Time Profile”: Another pre-defined energy usage profile includes a “night time profile” that automatically reduces energy consumption by powering down appropriate appliances and devices and manages the temperature appropriate for night-time.
4. “Workday/Away From Home Profile”: Another pre-defined energy usage profile is a “workday/away from home” profile that aggressively reduces consumption by powering down appropriate appliances and manages the temperature appropriate for when no one is home. In various embodiments, this particular profile randomly cycles one or more lights to simulate someone being home.
5. “Vacation Profile”: In addition, a “vacation profile” provides another pre-defined energy usage profile that reduces consumption by powering down appropriate appliances and devices and manages the temperature appropriate for when no one is home for extended periods of time. Again, this profile may also randomly cycle one or more lights to simulate someone being home.

Further, any or all of these profiles, including user-created or defined profiles, can be customized to add or remove particular appliances or devices, or to specify particular settings or operating parameters as a function of the real-time energy pricing information provided by the Smart Grid Pricer. In addition, in various embodiments, active or selected energy usage profiles are automatically adjusted (with respect to some or all devices under the control of such profiles) by the Smart Grid Pricer. See Section 2.6.1 for an example of various factors that are considered when automatically adjusting energy usage profiles.

2.6.1 Additional Considerations for Optimizing Energy Usage Profiles:

Clearly, there are a large number of factors that can be considered in an attempt to automatically optimize various energy usage profiles. Following is a list of a number of such factors. However, it should be understood that the following list is not intended to be an exclusive list, as it simply summarizes some of the many parameters that may be considered for optimizing energy management in the home, business, or other premise:
Current and future predicted price of electricity, and the time and rate of change between them;
Current and future predicted weather conditions, and the time and rate of change between them;
Current and future predicted price of natural gas;
Efficiencies of natural gas vs. electric heat in dual-heat systems;
Thermal, lighting, and other related characteristics of the home (e.g. how fast does it heat, cool, etc under different conditions);
Occupant HVAC environmental preferences (heating, cooling, humidity for individual times of the day, week, holidays, etc);
Occupant defined discretionary appliance usage parameters (hot water heater, fridge, freezer, dishwasher, clothes washer & dryer, lighting, computers, etc.);
Vehicle commuting information (e.g., how far does the HEV need to go before refueling, etc.);
Traffic information for commuting (to optimize gas consumption, electric vehicle charging, etc.);
Current and predicted future presence of occupants in home;
Calendars for occupants and where they are going (for electric vehicles);
Price of gasoline (vs. the price of electricity) and the efficiency of a plug-in HEV running under each fueling;
Current, forecast, and controllable local (i.e., consumer-based) energy generation outputs (e.g., solar, wind, battery storage, cogeneration, etc.);
Current and historical aggregate consumption;
Current and forecast peak usage on the electricity grid;
Manual overrides by occupants;
Forecast usage for month, and budget limits set (see Section 2.7 for a discussion of cost and energy usage caps);
Financial information that might affect running above/below budget;
Etc.

2.7 User Specified Cost and/or Energy Usage Caps:

In various embodiments, the Smart Grid Pricer allows the consumer to set either or both usage caps and energy cost caps so that energy costs or usage do not exceed some desired amount, either over some predefined period or as a real-time function. Towards this end, various embodiments of the Smart Grid Pricer also allow the consumer to prioritize one or more devices so that the energy consumption of particular devices can be automatically increased or decreased to meet particular consumer defined energy cost or usage caps.

For example, in the case where the consumer defines particular energy cost caps in combination with device prioritization, as the price of energy increases, the Smart Grid Pricer can perform automated operations such as, for example, ensuring that a high priority freezer maintains a particular temperature, while diming or turning off low priority lights or other devices such as air-conditioning or other appliances. Such automated operations allow the consumer side of the Smart Grid Pricer to maintain total energy usage or costs below the consumer-defined cap without requiring the consumer to interact directly with any of those devices.

For example, assuming that the consumer is on a fixed budget, the Smart Grid Pricer is capable of providing predictability in the energy bill. Consumers can set a target amount they wish to spend, and the system can steer usage and behavior accordingly to hit the target. Through a variety of factors, including analysis of previous electrical usage history, the time of the year and historical temperature patterns, the willingness of the homeowner to trade off comfort for savings, the degree of control over appliances, and other time-specific pricing information, the Smart Grid Pricer can forecast a target budget for a given month. It can then track actual usage against the goal, and alert the homeowner when the goal is off track with the goal of bringing more predictability and setting more accurate expectations for monthly electrical bills.

3.0 Exemplary Operating Environments:

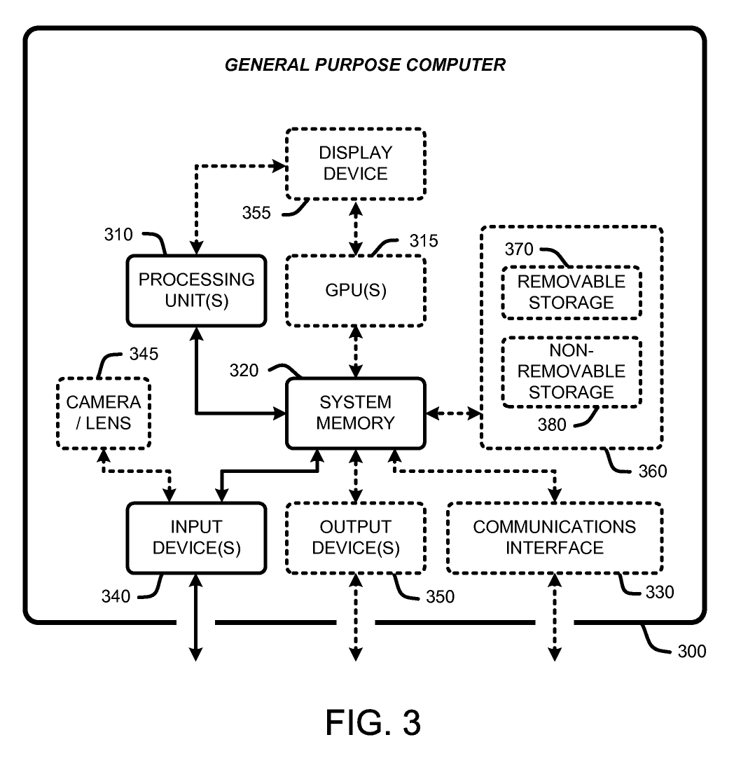

The Smart Grid Pricer described herein is operational within numerous types of general purpose or special purpose computing system environments or configurations. FIG. 3 illustrates a simplified example of a general-purpose computer system on which various embodiments and elements of the Smart Grid Pricer, as described herein, may be implemented. It should be noted that any boxes that are represented by broken or dashed lines in FIG. 3 represent alternate embodiments of the simplified computing device, and that any or all of these alternate embodiments, as described below, may be used in combination with other alternate embodiments that are described throughout this document.

For example, FIG. 3 provides a general system diagram showing a simplified computing device. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, video media players, etc.

To allow a device to implement the Smart Grid Pricer, the device has some computational, as illustrated by one or more processing unit(s) 310, and may also include one or more GPUs 315. Note that that the processing unit(s) 310 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 3 may also include other components, such as, for example, a communications interface 330. The simplified computing device of FIG. 3 may also include one or more conventional computer input devices 340. The simplified computing device of FIG. 3 may also include other optional components, such as, for example, one or more conventional computer output devices 350. Finally, the simplified computing device of FIG. 3 may also include storage 360 that is either removable 370 and/or non-removable 380. Note that typical communications interfaces 330, input devices 340, output devices 350, and storage devices 360 for general-purpose computers are well known to those skilled in the art, and will not be described in detail herein.

The foregoing description of the Smart Grid Pricer has been presented for the purposes of illustration and description. It is not intended to be exhaustive or to limit the claimed subject matter to the precise form disclosed. Many modifications and variations are possible in light of the above teaching. Further, it should be noted that any or all of the aforementioned alternate embodiments may be used in any combination desired to form additional hybrid embodiments of the Smart Grid Pricer. It is intended that the scope of the invention be limited not by this detailed description, but rather by the claims appended hereto.

What is claimed is:

1. A method for balancing energy supply with energy demand between a plurality of energy consumers and one or more energy providers, comprising steps for:
providing a statistical model of price-based energy demand characteristics of a plurality of energy consumers;
periodically evaluating the statistical model in combination with a model of available energy supply one or more energy providers to determine optimal real-time energy pricing for balancing an actual energy demand of the energy consumers relative to the available energy supply;
periodically reporting the real-time energy pricing to the energy consumers and the energy providers;
delivering energy to one or more of the each energy consumers from one or more of the energy providers; and
monitoring actual energy consumer energy usage over time to record the energy use of each energy consumer relative to the corresponding real-time energy pricing.

2. The method of claim 1 further comprising steps for staggering the periodic reporting of real-time energy pricing to one or more subgroups of the plurality of energy consumers to smooth real-time energy demand changes.

3. The method of claim 1 further comprising steps for providing real-time pricing that is automatically customized for one or more specific energy consumers to reflect actual energy delivery costs over corresponding energy transmission and distribution links.

4. The method of claim 1 further comprising steps for reporting the real-time energy pricing to the energy consumers via a tamper-resistant communications channel.

5. The method of claim 1 further comprising steps for allowing individual energy consumers to acknowledge receipt of reported real-time energy pricing via a tamper-resistant communications channel.

6. The method of claim 1 further comprising steps for defining one or more energy consumption preferences for individual energy consumers via a remotely accessible user interface.

7. The method of claim 1 further comprising steps for automatically driving energy consumption for one or more devices corresponding to one or more of the energy consumers based on a set of one or more user selectable rules.

8. The method of claim 1 further comprising steps for automatically controlling energy consumption of one or more devices via a “smart plug” inline between the one or more devices and the energy delivered to the corresponding energy consumer.

9. The method of claim 1 wherein monitoring the actual energy consumer energy usage over time comprises steps for recording the energy usage via a smart meter that is periodically read by the corresponding energy provider.

10. A system for providing a scalable intermediary service for balancing energy supply and demand between energy providers and energy consumers in real time, comprising:
a device for periodically modeling consumer energy demand characteristics of a group of energy consumers;
a device for periodically computing real-time energy pricing as a function of the modeled consumer energy demand characteristics relative to a limited variable energy supply level available for delivery from an energy provider;
wherein the real-time pricing is set at a level that is designed to closely balance current consumer energy demand relative to the current available energy supply levels;
a device for periodically reporting the real-time energy pricing to the group of energy consumers;
a device for distributing portions of the current available energy supply to each of the group of energy consumers based on the energy demand of each individual energy consumer; and
a device for monitoring actual consumer energy usage of each energy consumer relative to the corresponding real-time energy pricing.

11. The system of claim 10 further comprising a user interface device for allowing users to one or more energy consumption preferences from a set of predefined energy usage profiles for automatically modifying the energy demand of each individual energy consumer as a real-time function of the reported real-time energy pricing.

12. The system of claim 11 wherein the user interface is remotely accessible via a secure connection across the Internet.

13. The system of claim 10 further comprising a device for periodically computing and reporting expected energy pricing for predefined periods in the future, said expected energy pricing being based on probabilistic estimates of future energy demand characteristics of the group of energy consumers in combination with probabilistic estimates of future available energy supply levels.

14. The system of claim 10 further comprising a device for staggering the periodic reporting of real-time energy pricing to one or more subgroups of the group of energy consumers.

15. The system of claim 10 further comprising a “smart plug” device placed in-line between one or more devices associated with one or more of the energy consumers and the energy distributed to the corresponding energy consumer, said smart plug being used to automatically control energy consumption of the corresponding devices in response to the real-time energy pricing.

16. A computer-readable medium having computer executable instructions stored therein for computing real-time electricity prices for balancing electricity supply and demand between electricity providers and electricity consumers, said instructions comprising:
periodically modeling consumer electricity demand characteristics based on historical and current consumer electricity usage and a current and forecast available electricity delivery capacity;
periodically setting a real-time electricity price as a function of the modeled consumer electricity demand characteristics at a level intended to balance current consumer electricity demand relative to the available electricity delivery capacity;
periodically reporting the real-time electricity price to the electricity consumers via a staggered reporting wherein subgroups of the electricity consumers are notified over a period of time sufficient to partially smooth rapid changes in current consumer electricity usage;
delivering the available electricity to the electricity consumers; and
monitoring actual electricity usage of each electricity consumer relative to the corresponding real-time electricity price.

17. The computer-readable medium of claim 16 wherein periodically modeling consumer electricity demand characteristics is further based on energy consumption characteristics of electrical devices known to be associated with particular consumers.

18. The computer-readable medium of claim 16 wherein periodically modeling consumer electricity demand characteristics is further based on current and forecast weather conditions over a region encompassing the electricity consumers.

19. The computer-readable medium of claim 16 wherein the periodic reporting of the real-time electricity price is performed via a tamper-resistant communications channel.

20. The computer-readable medium of claim 16 further comprising instructions for defining one or more electricity consumption preferences for individual electricity consumers via a remotely accessible user interface.
